(19) United States
(12) Patent Application Publication
(10) Pub. No.: US 2026/0264736 A1
(43) Pub. Date: Sep. 10, 2026

(54) SHOPPING CART, METHOD, AND ITEM REGISTRATION DEVICE

(71) Applicant: Toshiba Tec Kabushiki Kaisha, Tokyo (JP)

(72) Inventor: Sou KIZAWA, Fuji Shizuoka (JP)

(21) Appl. No.: 19/448,013

(22) Filed: Jan. 13, 2026

(30) Foreign Application Priority Data
Mar. 10, 2025 (JP) 2025-037644

(51) Int. Cl. B62B 5/00; B62B 3/14; G01G 19/415; G01G 19/52

(52) U.S. Cl. CPC B62B 5/0096; B62B 3/1412; B62B 3/1424; G01G 19/415; G01G 19/52

(57) ABSTRACT

A shopping cart includes frames on which containers for storing one or more items can be placed, a weight sensor, a scanner, a display, and a processor configured to, upon reading of identification information by the scanner, register an item associated with the identification information for purchase, determine whether a weight of the containers measured by the weight sensor decreases, in response to determining that the weight decreases, determine one or more candidate items corresponding to an amount of the decrease in the weight from among registered items, generate a cancellation screen on the display, the cancellation screen displaying the one or more candidate items in a selectable manner, and upon selection of one of the one or more candidate items through the cancellation screen, cancel registration of the selected item.

### CROSS-REFERENCE TO RELATED APPLICATIONS

This application is based upon and claims the benefit of priority from Japanese Patent Application No. 2025-037644, filed Mar. 10, 2025, the entire contents of which are incorporated herein by reference.

### FIELD

Embodiments described herein relate generally to a shopping cart, a method, and an item registration device.

### BACKGROUND

Conventionally, there is known a shopping cart used for shopping in a store, such as a supermarket, that is provided with a terminal device having a registration function capable perform registration of an item and cancellation of a registered item.

By using such a shopping cart, the customer can instruct, via the terminal device, the registration of an item that the customer wants to purchase and the cancellation of the registered item.

However, there are cases where the cancellation of an item is not performed properly, such as when a customer unintentionally returns an item different from the item for which cancellation was instructed, or when a customer forgets to return an item despite having instructed the cancellation of the item. Therefore, there is a demand for a shopping cart provided with a terminal device having a registration function that enables a customer to reliably cancel an item is desired.

### SUMMARY OF THE INVENTION

Embodiments of the present disclosure provide a shopping cart, a method, and an item registration device.

A shopping cart comprises: one or more frames on which one or more containers for storing one or more items can be placed; a weight sensor configured to measure a weight of the one or more containers placed on the one or more frames; a scanner configured to read identification information identifying an item; a display attached to the one or more frames; a memory that stores a program; and a processor configured to execute the program to: upon reading of identification information by the scanner, register an item associated with the identification information for purchase, determine whether a weight of the one or more containers measured by the weight sensor decreases, in response to determining that the weight decreases, determine one or more candidate items corresponding to an amount of the decrease in the weight from among registered items, generate a cancellation screen on the display, the cancellation screen displaying the one or more candidate items in a selectable manner, and upon selection of one of the one or more candidate items through the cancellation screen, cancel registration of the selected item.

### BRIEF DESCRIPTION OF THE DRAWINGS

FIG. 1 is a perspective view illustrating a shopping cart according to an embodiment.

FIG. 2 is a hardware block diagram of the shopping cart.

FIG. 3 is a diagram illustrating an example of a data structure of an item master.

FIG. 4 is a diagram illustrating an example of a data structure of an item registration file.

FIG. 5 is a functional block diagram of the shopping cart.

FIG. 6 is a diagram illustrating an example of a screen displayed on a display of the shopping cart.

FIG. 7 is a diagram illustrating another screen example displayed on the display of the shopping cart.

FIG. 8 is a diagram illustrating another example of a screen displayed on the display of the shopping cart.

FIG. 9 is a flowchart of processing performed by the shopping cart.

FIG. 10 is a diagram illustrating an example of a screen displayed on a display of a shopping cart according to a first modification.

FIG. 11 is a diagram illustrating another screen example displayed on the display of the shopping cart according to the first modification.

FIG. 12 is a flowchart of processing performed by the shopping cart according to the first modification.

### DETAILED DESCRIPTION

Hereinafter, embodiments will be described in detail with reference to the drawings. Embodiments of the present disclosure are not limited to the ones described below.

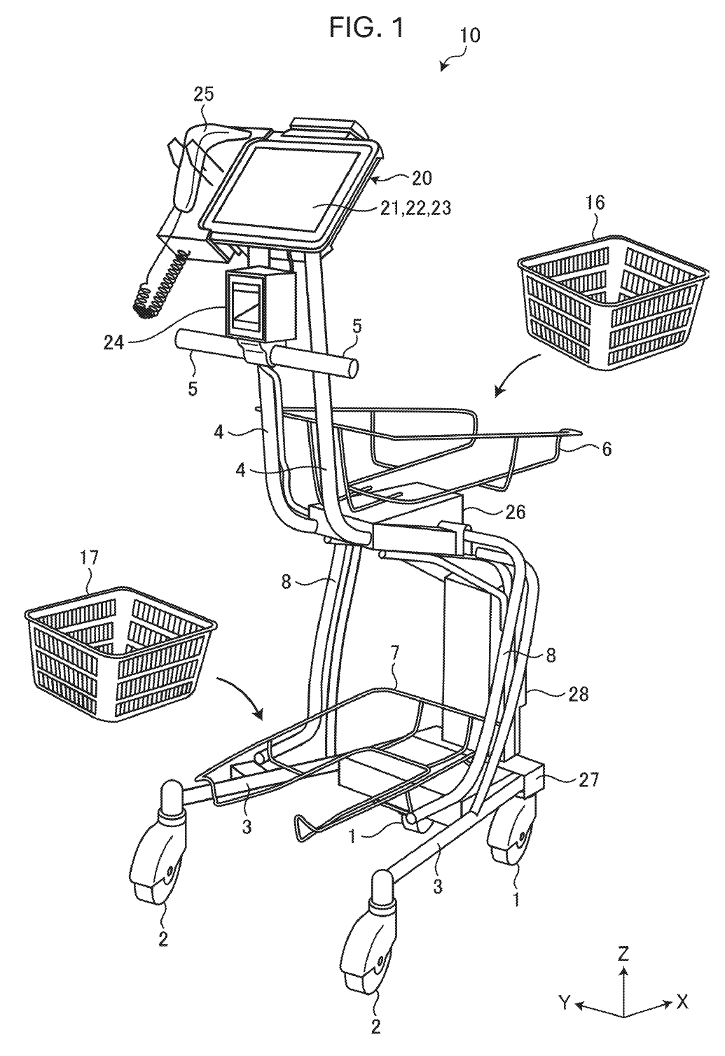

First, a schematic configuration of a shopping cart 10 will be described with reference to FIG. 1. FIG. 1 is a perspective view of the shopping cart 10 according to an embodiment.

The shopping cart 10 reads item information of an item that a customer wants to purchase while the customer pushes the shopping cart 10 around the store, and performs registration of the item. The customer keeps shopping by putting the registered item in the shopping basket placed on the shopping cart 10. After the shopping is completed, the customer goes to a checkout machine (not illustrated) and performs a settlement process related to the registered item using the checkout machine. The shopping cart 10 itself may have a function of performing the settlement process. The shopping cart 10 is an example of an item registration device for shopping cart in the present disclosure.

The shopping cart 10 includes a pair of bottom frames 3, each of which includes a front wheel 1 and a rear wheel 2. A pair of upper frames 4 extending upward are connected to the pair of bottom frames 3. The front wheel 1 and the rear wheel 2 are respectively mounted on casters capable of freely rotating around a mounting shaft to the bottom frame 3. Therefore, the direction of travel of the shopping cart 10 can be changed to the left or right according to the force applied to the pair of handles 5 installed above the shopping cart 10. That is, the shopping cart 10 is capable of changing directions. The customer holds the pair of handles 5 and pushes the shopping cart while walking and changing the direction of the shopping cart 10 to the left and right.

A charge controller 27 is mounted between the pair of bottom frames 3. The charge controller 27 includes a charging circuit (not shown), and charges the battery 28 by the charging circuit. Although detailed description is omitted, the charge controller 27 includes an input connector and an output connector, and charges the battery 28 with power supplied from a power supply device (not shown) in a state where a plurality of shopping carts 10 are stacked. The charge controller 27 also serves as a structural member for connecting the left and right bottom frames 3.

An upper frame 4 is attached to the front side (+ X direction side) of the bottom frame 3, the upper frame 4 rising upward (+ Z direction), then extending obliquely upward toward the front (- X direction), and then extending upward (+ Z direction). The upper frame 4 holds the battery 28. The battery 28 is a rechargeable secondary battery that supplies current to various electronic devices included in the shopping cart 10. The battery 28 is, for example, a lithium ion battery, a nickel cadmium battery, a nickel hydrogen battery, a lead storage battery, or the like.

An upper basket support frame 6 is attached to the upper frame 4. A shopping basket 16 for accommodating items when a customer performs shopping is placed on the upper basket support frame 6. The shopping basket 16 is an example of a container in the present disclosure.

A lower basket support frame 7 is attached to the upper side of the bottom frame 3. A shopping basket 17 for accommodating items when a customer performs shopping is placed on the lower basket support frame 7. The shopping basket 17 is an example of a container in the present disclosure. The lower basket support frame 7 is attached to a pair of suspension frames 8 extending downward from the upper basket support frame 6.

A weight sensor 26 is installed immediately below the upper basket support frame 6 at a position where the upper frame 4 extends to the front side (- X direction). The weight sensor 26 measures the sum of the weight of the items accommodated in the shopping basket 16 placed on the upper basket support frame 6 and the weight of the items accommodated in the shopping basket 17 placed on the lower basket support frame 7. In this way, the lower basket support frame 7 is connected to the upper basket support frame 6 by the pair of suspension frames 8, and thus the total weight of the weight of the items stored in the shopping basket 16 and the weight of the items stored in the shopping basket 17 is detected by the weight sensor 26. The weight sensor 26 is a known sensor such as a strain gauge whose electric resistance changes according to expansion and contraction, for example.

A tablet terminal 20 and a hand scanner 25 are installed on the upper portions of the pair of upper frames 4. A fixed scanner 24 is installed at the center of the pair of handles 5. All of these electronic devices operate on the power of the battery 28.

The tablet terminal 20 registers an item that a customer desires to purchase. The tablet terminal 20 includes a display 21, a touch panel 22, and an acceleration sensor 23. The tablet device 20 may further have a function of performing payment related to the registered item.

The display 21 displays various information related to registration of an item. The display 21 is, for example, a liquid crystal monitor or an organic EL monitor.

The touch panel 22 is stacked on the display 21 and detects operations on various buttons displayed on the display 21.

The acceleration sensor 23 detects whether the shopping cart 10 is in a moving state and whether the shopping cart 10 is in a tilted state from a horizontal state. The acceleration sensor 23 is realized by using a known functional element such as a piezoelectric element that detects the amount of charge generated in accordance with applied vibration or a piezoelectric element whose electric resistance changes in accordance with applied pressure. The acceleration sensor 23 may be a combination of an acceleration sensor and a gyro sensor. The acceleration sensor 23 may be incorporated in the weight sensor 26.

The fixed scanner 24 reads a code symbol such as a barcode attached to an item to be sold, which is held over a reading window on the front surface. Identification information (for example, item code) that uniquely identifies the item is registered in the code symbol. The fixed scanner 24 decodes the reading result of the code symbol to acquire the item code.

The hand scanner 25 reads the code symbol attached to the item and acquires the item code, similarly to the fixed scanner 24. In particular, the hand scanner 25 is used when reading a code symbol of an item, such as a heavy object or a large item, whose code symbol is difficult to read by the fixed scanner 24.

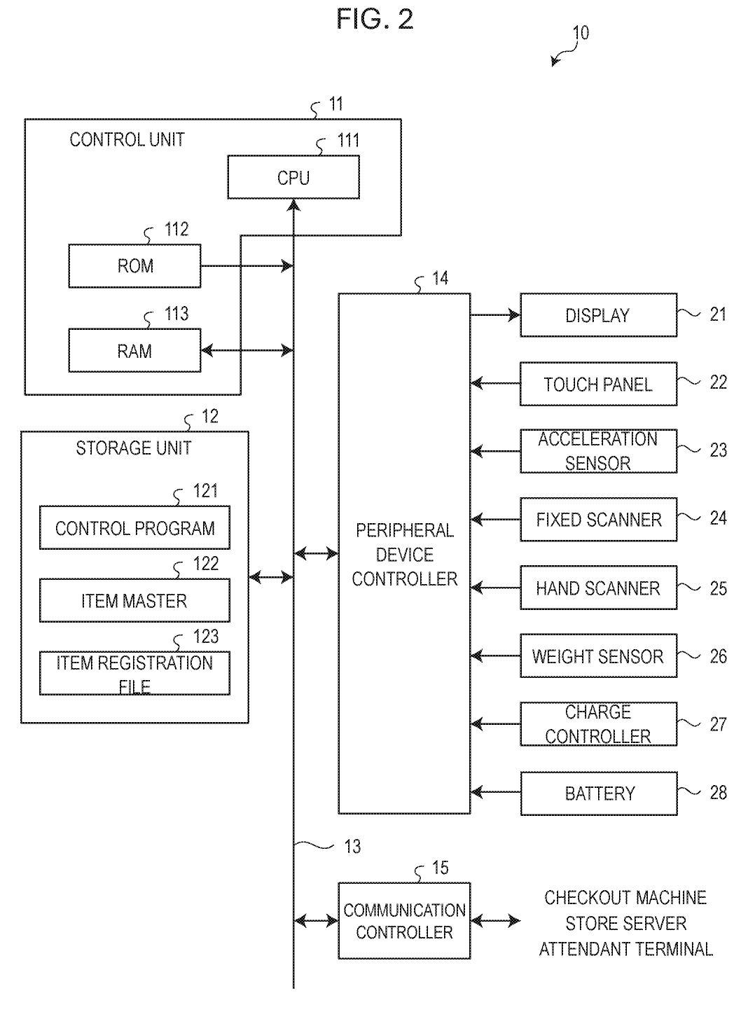

Next, a hardware configuration of the shopping cart 10 will be described with reference to FIG. 2. FIG. 2 is a hardware block diagram of the shopping cart 10 according to an embodiment.

The shopping cart 10 has a configuration in which a control unit 11, a storage unit 12, a peripheral device controller 14, and a communication controller 15 are connected to each other via an internal bus 13.

The control unit 11 controls the overall operation of the shopping cart 10. The control unit 11 includes a central processing unit (CPU) 111, a read only memory (ROM) 112, and a random access memory (RAM) 113. The CPU 111 is connected to the ROM 112 and the RAM 113 via internal buses such as address buses and data buses. The CPU 111 loads various programs stored in the ROM 112 or the storage unit 12 into the RAM 113. The CPU 111 operates according to various programs loaded into the RAM 113, thereby controlling the operation of the shopping cart 10. That is, the control unit 11 has a configuration of a general computer.

The storage unit 12 is a storage device such as a hard disk drive (HDD) or a solid state drive (SSD). The storage unit 12 may be a nonvolatile memory such as a flash memory that retains stored information even when the power is turned off. The storage unit 12 stores a control program 121, an item master 122, and an item registration file 123.

The control program 121 is a program that controls the overall operation of the shopping cart 10. The control program 121 may be stored in the storage unit 12, or may be provided by being recorded in a computer-readable non-transitory recording medium such as a CD-ROM, a flexible disk (FD), a CD-R, or a DVD in a file of an installable format or an executable format. The control program 121 may be stored in a computer connected to a network and provided by downloading via the network. Further, the control program 121 may be provided or distributed via a network such as the Internet.

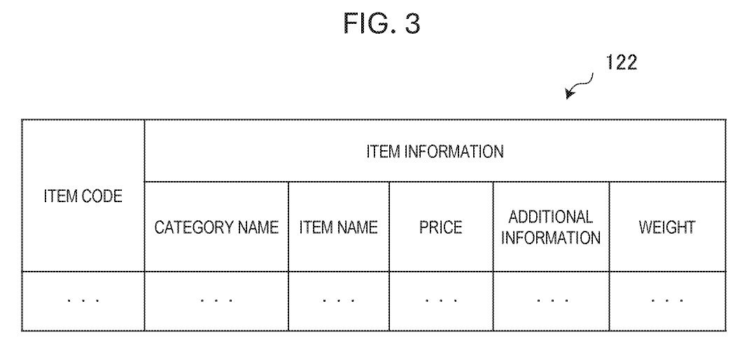

The item master 122 is a master file that stores item information such as the item name and price of the item to be sold. The item master 122 stores item information in association with identification information for uniquely identifying an item, for example, an item code. The data structure of the item master 122 will be described in detail later (see FIG. 3). Note that, since the content of the item master is updated as needed, the shopping cart 10 acquires the latest item master from, for example, a store server (not illustrated) via the communication controller 15, thereby always maintaining the content of the item master 122 in the latest state.

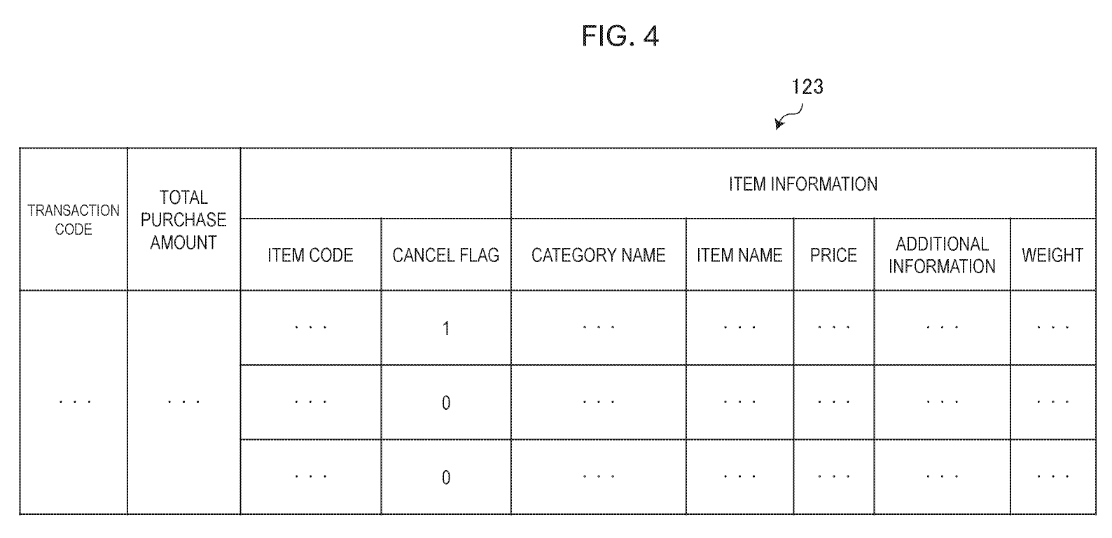

The item registration file 123 stores registered item information (for example, item name, number, unit price, and the like), a total purchase amount, and the like in association with a transaction code for specifying one transaction. The data structure of the item registration file 123 will be described in detail later (see FIG. 4).

The control unit 11 is connected to various peripheral devices, such as a display 21, a touch panel 22, an acceleration sensor 23, a fixed scanner 24, a hand scanner 25, a weight sensor 26, a charge controller 27, and a battery 28, via a peripheral device controller 14. The outline of each peripheral device is as described above, and thus the description thereof will not be repeated.

The control unit 11 also exchanges various types of information with a checkout machine, a store server, and an attendant terminal, all of which are not shown, via the communication controller 15.

For example, the control unit 11 obtains the latest item master from the store server. The control unit 11 outputs the item registration file 123 to the store server for sales management of the store.

The control unit 11 also notifies the attendant terminal that the customer has committed a fraudulent act such as placing an unregistered item in the shopping baskets 16 and 17.

The control unit 11 outputs the content of the item registration file 123 to the checkout machine in order to perform settlement.

Next, the data structure of the item master 122 will be described with reference to FIG. 3. FIG. 3 is a diagram illustrating an example of a data structure of the item master 122.

The item master 122 stores item information in association with an item ID (for example, an item code). The item information includes a category name, an item name, a price, additional information, and a weight.

The category name is the name of the category to which the item belongs.

The item name is the name of the item.

The price is a unit price of the item.

The additional information is other information related to the classification of the item and the price. For example, the additional information includes discount information such as a limited-time offer and a limited-time price, tax rate information according to a sales style such as dining-in and take-out, and the like.

The weight is the weight of the item. For example, the weight may vary slightly for each item even if the items have the same item ID. Therefore, in the present embodiment, the weight is defined by an upper limit value and a lower limit value for each item ID.

The information stored in the item master 122 is not limited to the information illustrated in FIG. 3.

Next, the data structure of the item registration file 123 will be described with reference to FIG. 4. FIG. 4 is a diagram illustrating an example of a data structure of the item registration file 123 stored in the shopping cart 10.

The item registration file 123 stores a total purchase amount, an item code, a cancel flag, and item information in association with a transaction ID (for example, a transaction code) for identifying one transaction. The item information includes a category name, an item name, a price, additional information, and a weight.

The total purchase amount is the total amount of items that the customer wishes to purchase in one transaction. It is assumed that the total purchase amount is calculated based on only the item corresponding to the item code in which a cancel flag described later is invalid.

The item code and the item information are the same as those described in the item master 122, and thus, the description thereof will not be repeated.

The cancel flag is information for identifying whether or not the item corresponding to the item code associated with the cancel flag is an item whose registration has been cancelled (hereinafter also referred to as a cancelled item). For example, the cancel flag is binary flag information that is "1" when the flag is valid (hereinafter also referred to as an on state) and "0" when the flag is invalid (hereinafter also referred to as an off state).

Specifically, when the cancel flag is in the off state, the control unit 11 of the shopping cart 10 determines that the item is in a state where the registration is valid. When the cancel flag is on state, the control unit 11 of the shopping cart 10 determines that the item is an item whose registration is invalid, in other words, a cancelled item.

The item registration file 123 may be configured not to store the item information. In this case, the total purchase amount is calculated by acquiring item information from the item master 122 for the item corresponding to the item code with the cancel flag in the off state.

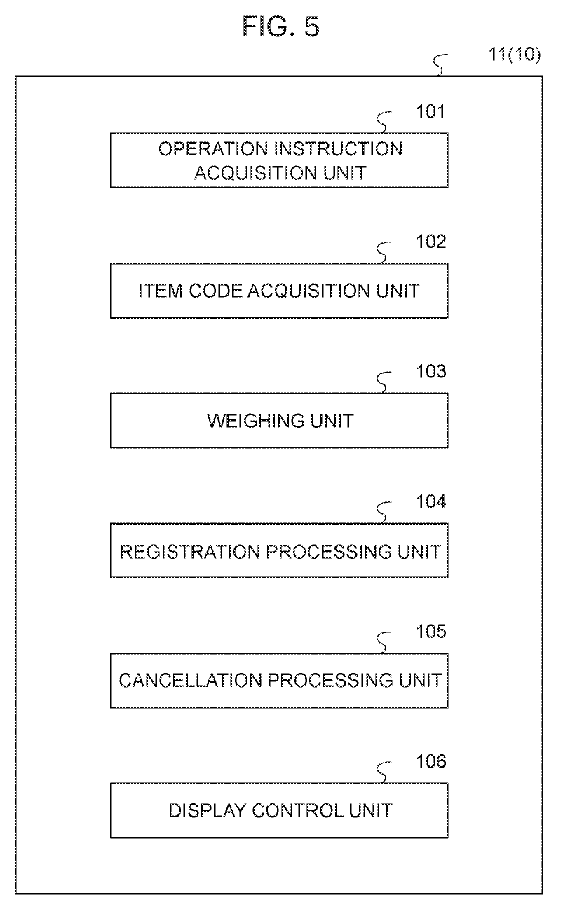

Next, a functional configuration of the shopping cart 10 will be described with reference to FIG. 5. FIG. 5 is a functional block diagram of the shopping cart 10.

The control unit 11 of the shopping cart 10 includes an operation instruction acquisition unit 101, an item code acquisition unit 102, a weighing unit 103, a registration processing unit 104, a cancellation processing unit 105, and a display control unit 106 as functional configurations by loading and operating a control program 121 in the RAM 113.

To be specific, the control unit 11 (CPU 111) of the shopping cart 10 has a software configuration that realizes the above-described functional configuration by executing the control program 121 stored in the storage unit 12. The control unit 11 is not limited to this, and may have a hardware configuration in which a part or all of the functional configuration is realized by a dedicated circuit or the like. The functional configuration of the shopping cart 10 is not limited to this.

The operation instruction acquisition unit 101 acquires an instruction to start item registration from a customer. Specifically, the operation instruction acquisition unit 101 determines that the start of the item registration is instructed when detecting that an item registration start button (not shown) displayed on the display 21 is operated.

The operation instruction acquisition unit 101 receives selection of an item to be cancelled. Specifically, the operation instruction acquisition unit 101 receives selection of an item to be cancelled from items to be registration cancellation candidates (hereinafter, also referred to as cancellation candidates) displayed on the display 21.

The operation instruction acquisition unit 101 acquires an instruction from the customer indicating that registration of all items is completed. Specifically, when the operation instruction acquisition unit 101 detects that the operator for performing accounting displayed on the display 21 is operated, the operation instruction acquisition unit 213 determines that the completion of the registration of all the items is instructed.

The item code acquisition unit 102 acquires identification information (for example, an item code) of an item. Specifically, the item code acquisition unit 102 acquires the item code registered in the code symbol read by the fixed scanner 24 or the hand scanner 25. The item code acquisition unit 102 acquires an item code input via the touch panel 22.

The weighing unit 103 cooperates with the weight sensor 26 to measure the weight of the items contained in the shopping cart 10. Specifically, the weighing unit 103 measures the weight of the shopping baskets 16 and 17 containing the item whose item code has been acquired, based on the detection result of the weight sensor 26.

The registration processing unit 104 registers the item for which the identification information is acquired. Specifically, the registration processing unit 104 refers to the item master 122 and acquires item information corresponding to the identification information (for example, item code) of the item acquired by the item code acquisition unit 102.

The registration processing unit 104 executes registration processing of the acquired item information based on a change in the weight measured by the weighing unit 103.

Specifically, when the registration processing unit 104 determines that the weight measured by the weighing unit 103 has increased, the registration processing unit 104 determines whether the increased weight is within the range of the set weight of the item for which the item information has been acquired.

Here, when the registration processing unit 104 determines that the increased weight is within the range of the weight set for the item for which the item information has been acquired, the registration processing unit 104 registers the item code and the acquired item information in the item registration file 123 in a state where the cancel flag is set to the off state. When the registration processing unit 104 determines that the increased weight is not within the range of the weight set for the item for which the item information has been acquired, the registration processing unit 104 cooperates with the display control unit 106 described later to display notification information on the display 21.

For example, After the item information of the item X whose weight is set to “90g to 110g” in the item master 122 is acquired, when the registration processing unit 104 determines that the weight of the shopping baskets 16 and 17 is increased by “120g”, there is a possibility that the customer stores an item different from the item X in the shopping baskets 16 and 17. Therefore, in such a case, the registration processing unit 104 cooperates with the display control unit 106 described later to display a message on the display 21 to notify the customer that an item different from the item corresponding to the acquired item code may have been accommodated in the shopping baskets 16 and 17.

When the weight measured by the weighing unit 103 does not change even after a predetermined time (for example, 10 seconds) elapses after the item information is acquired, the registration processing unit 104 cooperates with the display control unit 106 described later to display a message prompting the customer to put the item in the shopping baskets 16 and 17 on the display 21.

In addition, when the registration processing unit 104 determines that the weight measured by the weighing unit 103 has increased even though the item information has not been acquired, the registration processing unit 104 may display notification information including a message for confirming whether the customer is performing a fraudulent act on the display 21 in cooperation with the display control unit 106 to be described later.

The cancellation processing unit 105 cancels the item registered by the registration processing unit 104. Specifically, when the weight measured by the weighing unit 103 is reduced, the cancellation processing unit 105 extracts an item corresponding to the reduced weight from among the items whose cancel flags registered in the item registration file 123 are in the off state.

For example, when the reduced weight is "100g", the cancellation processing unit 105 extracts an item in which "100g" that is the reduced weight, is included in the set weight range, among the items in which the cancel flag registered in the item registration file 123 is in the off state. Here, the extracted item corresponds to a cancel candidate.

The cancellation processing unit 105 cooperates with the display control unit 106 described later to display a screen on which the extracted items are displayed in a selectable manner on the display 21. Further, when the operation instruction acquisition unit 101 receives the selection of the item to be cancelled, the cancellation processing unit 105 refers to the item registration file 123 and changes the cancel flag of the item of which the selection is received to the on state. Accordingly, the cancellation processing unit 105 cancels the registered item. Then, the cancellation processing unit 105 cooperates with the display control unit 106 described later to display a screen reflecting the state of the cancel flag on the display 21. More specifically, the cancellation processing unit 105 cooperates with the display control unit 106 described later to cause the display 21 to display items with the cancel flag in the off state and items with the cancel flag in the on state in a distinguishable manner.

The display control unit 106 cooperates with other functional units to display various screens on the display 21.

Hereinafter, an example of a screen displayed on the display 21 of the shopping cart 10 will be described.

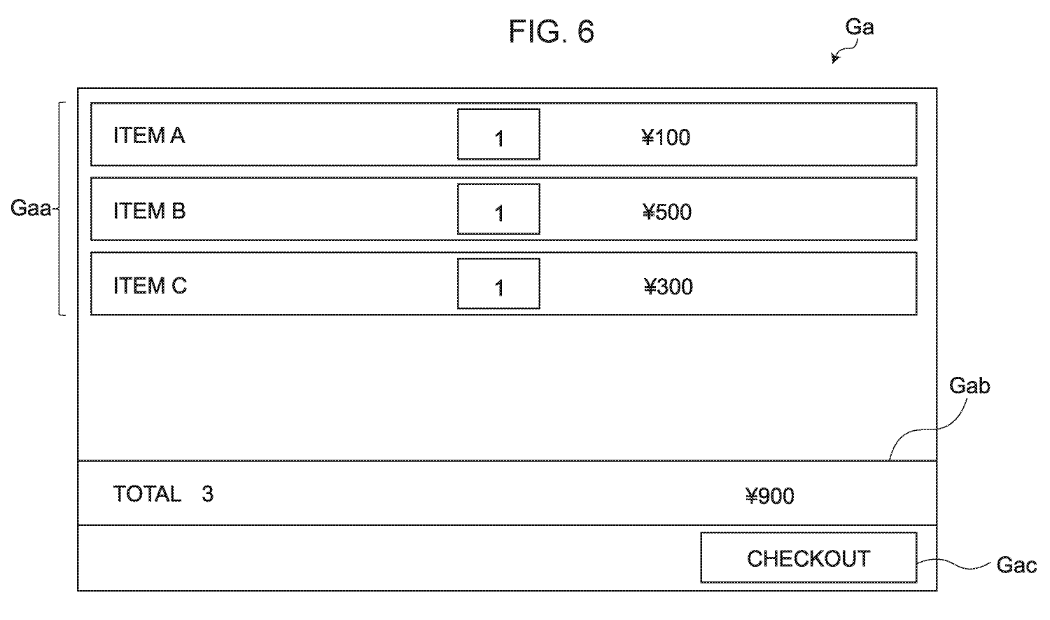

FIG. 6 is a diagram illustrating an example of a screen displayed on the display 21 of the shopping cart 10. FIG. 6 shows an example of an item registration screen Ga displayed on the display 21 in a state where a plurality of items are registered in the item registration file 123.

In the item registration screen Ga, item information associated with an item (item code) in which the cancel flag registered in the item registration file 123 is in the off state is displayed. For example, when "item A", "item B", and "item C" are registered in the item registration file 123 with the cancel flag in the off state, the item registration screen Ga as shown in FIG. 6 is displayed on the display 21.

As illustrated in FIG. 6, for example, a registration detail field Gaa, a total purchase amount field Gab, and a checkout button Gac are displayed on the item registration screen Ga.

The registration detail field Gaa displays item information registered in the item registration file 123 by the registration processing unit 104. For example, the registration detail field Gaa includes an item name, the number of purchased items (quantity) of the item, an amount of money calculated based on the number of purchased items and a price (unit price), and the like.

The total purchase amount field Gab displays the total purchase amount of the item registration file 123. Specifically, the total purchase amount field Gab displays the number of items for which the cancel flag displayed in the registration detail field Gaa is in the off state, and the total amount calculated based on the number of items purchased and the price (unit price) for each item.

The checkout button Gac is an operation element for declaring that registration of all items that the customer desires to purchase is completed. For example, when the checkout button Gac is operated, the operation instruction acquisition unit 101 determines that the registration of the items is completed, and transmits item information related to the items of which the cancel flag is in the off state among the item information registered in the item registration file 123 to the checkout machine (not illustrated).

Next, another screen example displayed on the display 21 of the shopping cart 10 will be described.

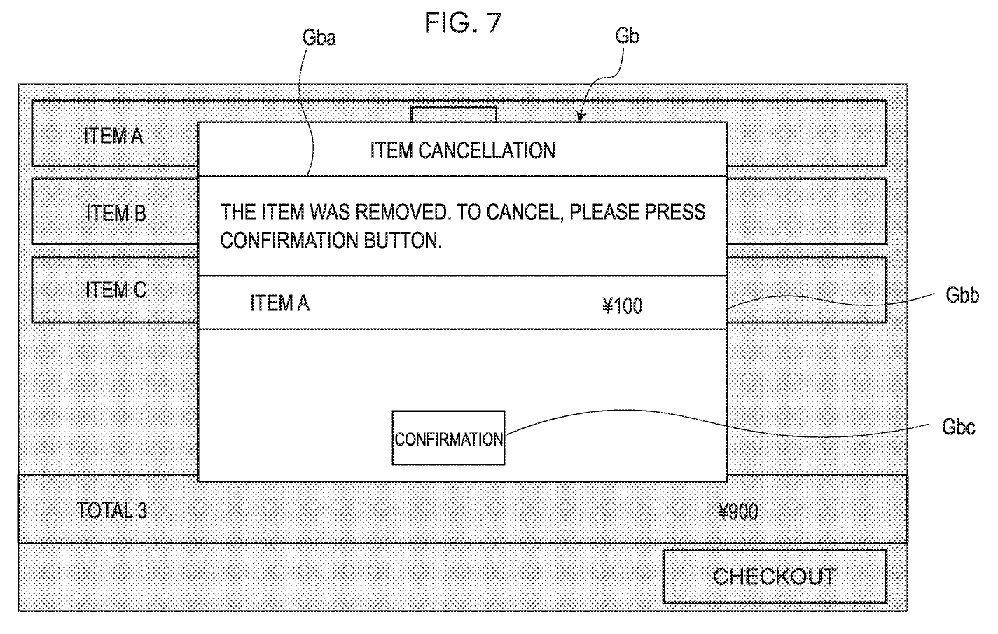

FIG. 7 is a diagram illustrating another screen example displayed on the display 21 of the shopping cart 10. FIG. 7 shows an example of a cancellation candidate screen Gb displayed on the display 21 when the cancellation processing unit 105 determines that the weight of the shopping baskets 16 and 17 has decreased.

As an example of a situation in which the cancellation candidate screen Gb is displayed, the following case is considered. When the customer takes out an item from the shopping baskets 16 and 17 in order to return the item, the weight measured by the weighing unit 103 is reduced by the weight of the item taken out. When the cancellation processing unit 105 determines that the weight measured by the weighing unit 103 has decreased, the cancellation processing unit 105 extracts an item corresponding to the decreased weight. Then, the cancellation processing unit 105 cooperates with the display control unit 106 to display a cancellation candidate screen Gb in which the extracted items (candidate items) are displayed in a selectable manner.

For example, when the item corresponding to the decreased weight is only "item A", the cancellation candidate screen Gb as shown in FIG. 7 is displayed on the display 21. When the cancellation processing unit 105 extracts a plurality of items from the item registration file 123, the plurality of extracted items are displayed in the cancellation candidate screen Gb so as to be selectable.

As illustrated in FIG. 7, the display control unit 106 may display the cancellation candidate screen Gb so as to be superimposed on the item registration screen Ga. In this case, for the purpose of clearly indicating selectable screens to the customer, it is preferable to display the item registration screen Ga grayed out.

As illustrated in FIG. 7, for example, a message Gba, a cancellation candidate field Gbb, and a confirmation button Gbc are displayed on the cancellation candidate screen Gb.

The message Gba is, for example, text for notifying the customer that the item has been taken out from the shopping baskets 16 and 17. The message Gba includes an operation instruction in the cancellation candidate screen Gb.

In the cancellation candidate field Gbb, a list of items extracted from the item registration file 123 by the cancellation processing unit 105, in other words, cancellation candidates are displayed in a selectable manner. For example, the cancellation candidate field Gbb includes an item name, an amount of money calculated based on the number of purchased items and a price (unit price), and the like. The customer selects an item to be cancelled by selecting any item from the cancellation candidates displayed in the cancellation candidate field Gbb.

The confirmation button Gbc is an operation element for confirming the selection of the item to be canceled. When the confirmation button Gbc is operated, the operation instruction acquisition unit 101 accepts the item selected in the cancellation candidate field Gbb as an item to be cancelled.

For example, in the cancellation candidate screen Gb illustrated in FIG. 7, when the confirmation button Gbc is operated, the cancellation candidate displayed in the cancellation candidate field Gbb is only "item A", and thus the operation instruction acquisition unit 101 accepts "item A" as the item to be cancelled. Then, the cancellation processing unit 105 refers to the item registration file 123 and changes the cancel flag of "item A", which is the item to be cancelled and is accepted by the operation instruction acquisition unit 101, to the on state. That is, the cancellation processing unit 105 sets "item A" as a cancelled item.

In a case where a plurality of items are displayed in the cancellation candidate field Gbb, the operation instruction acquisition unit 101 accepts the selected item as an item to be cancelled by having any item selected from the cancellation candidates displayed in the cancellation candidate field Gbb and then having the confirmation button Gbc operated.

Note that the operation instruction acquisition unit 101 may accept the selected item as an item to be cancelled triggered by the selection of the item in the cancellation candidate field Gbb. In other words, when an item is selected in the cancellation candidate field Gbb, the operation instruction acquisition unit 101 may accept the selected item as an item to be cancelled without waiting for the operation of the confirmation button Gbc.

Next, another screen example displayed on the display 21 of the shopping cart 10 will be described.

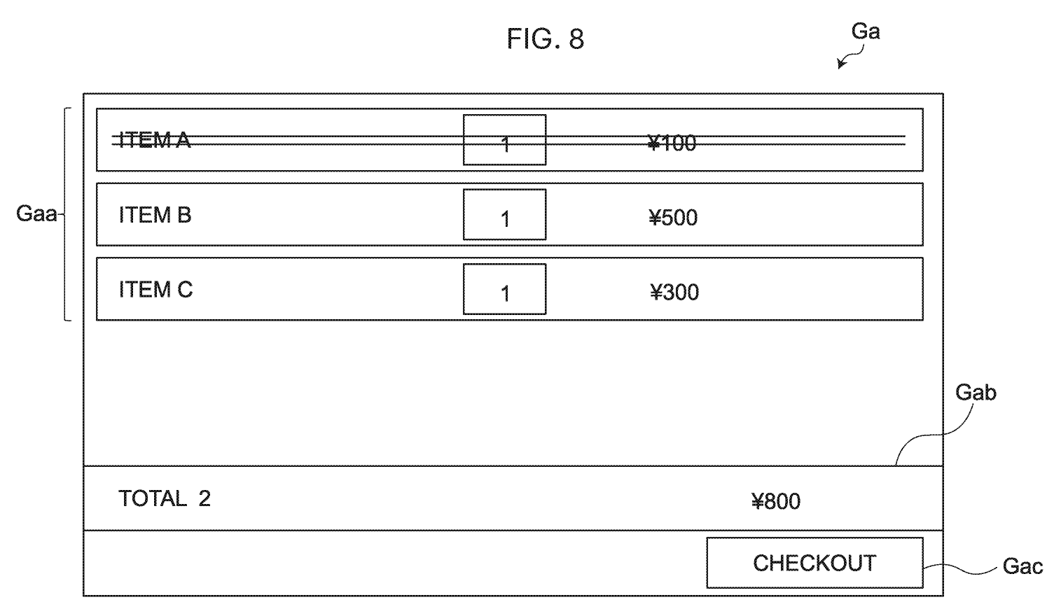

FIG. 8 is a diagram illustrating another screen example displayed on the display 21 of the shopping cart 10. FIG. 8 shows an example of a screen of an item registration screen Ga displayed on the display 21 when "item A" is selected from the cancellation candidate field Gbb in the cancellation candidate screen Gb of FIG. 7.

The cancellation processing unit 105 cooperates with the display control unit 106 to display the item selected from the cancellation candidate field Gbb, that is, the cancellation item on the cancellation candidate screen Gb on the display 21 so as to be distinguishable from other items.

For example, in the cancellation candidate screen Gb, when "item A" is selected from the cancellation candidate field Gbb, as illustrated in FIG. 8, the cancellation processing unit 105 cooperates with the display control unit 106 to superimpose a double line or the like on the display area of the item information of "item A" displayed in the registration detail field Gaa. This makes it possible to clarify that "item A" is a cancelled item. The display method for indicating the cancel item is not limited to the above. For example, the cancellation processing unit 105 may cooperate with the display control unit 106 to gray out and display the display area of the item information of the cancelled item. In addition, the cancellation processing unit 105 may cooperate with the display control unit 106 so as not to display the item with the cancel flag in the on state, that is, the cancel item, in the registration detail field Gaa of the item registration screen Ga.

In addition, the total purchase amount field Gab displays the number of items for which the cancel flag displayed in the registration detail field Gaa is in the off state, and the total amount calculated based on the number of purchased items and the price (unit price) for each item.

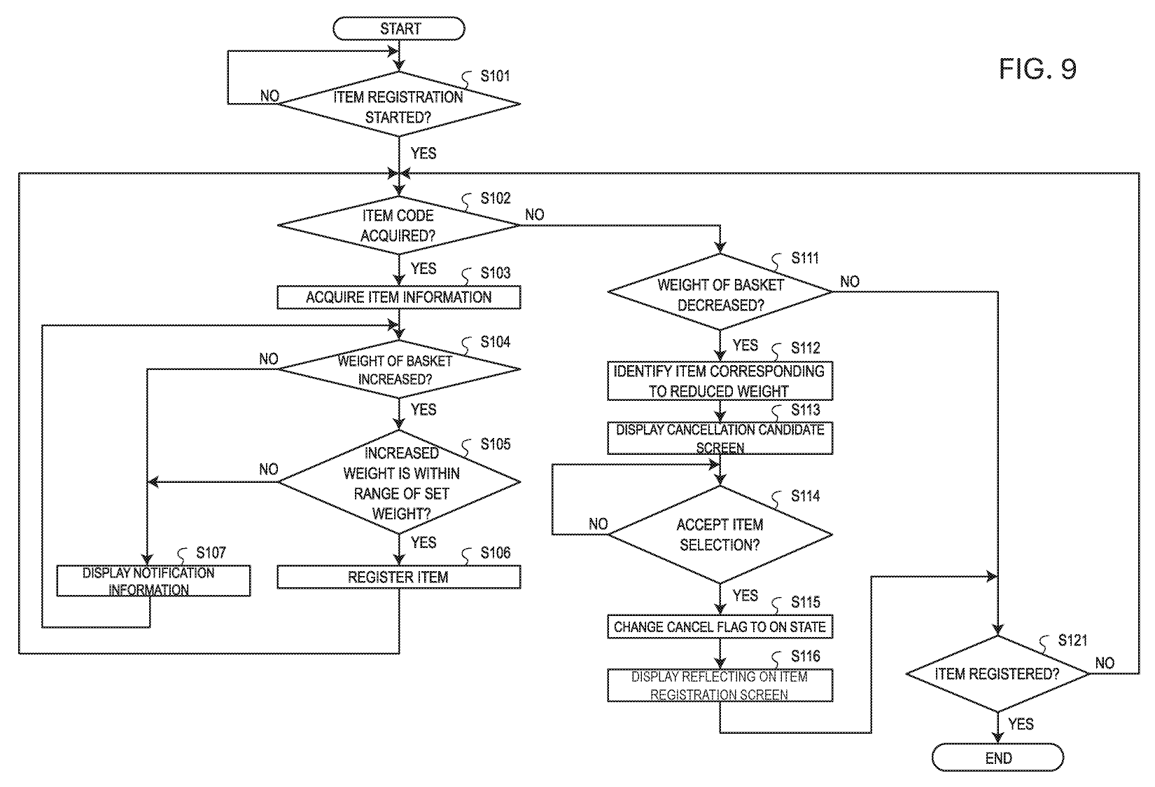

Next, a process performed by the shopping cart 10 (item registration device for shopping cart) will be described with reference to FIG. 9. FIG. 9 is a flowchart of processing performed by the shopping cart 10. It is assumed that the item registration screen Ga is displayed on the display 21.

First, the operation instruction acquisition unit 101 determines whether or not the customer has started item registration (step S101). When it is determined that the customer has not started the item registration (step S101; No), the control unit 11 repeats the determination of step S101. When it is determined that the customer has started the item registration (step S101; Yes), the item code acquisition unit 102 determines whether or not the item code has been acquired (step S102).

In step S102, when it is determined that the item code is acquired (step S102; Yes), the registration processing unit 104 refers to the item master 122 and acquires item information corresponding to the acquired item code (step S103). Next, the registration processing unit 104 determines whether the weight of the shopping baskets 16 and 17 has increased based on the weight measured by the weighing unit 103 (step S104).

When it is determined that the weight of the shopping baskets 16 and 17 has not increased (step S104; No), the control unit 11 advances the processing to step S107. On the other hand, when it is determined that the weight of the shopping baskets 16 and 17 has increased (step S104; Yes), the registration processing unit 104 determines whether the increased weight is within the range of the weight set for the item corresponding to the item information acquired in step S103 (step S105).

In step S105, when it is determined that the increased weight is within the range of the set weight of the item corresponding to the item information acquired in step S103 (step S105; Yes), the registration processing unit 104 registers the item information acquired in step S103 in the item registration file 123 in a state where the cancel flag is set to the off state (step S106).

In step S105, when it is determined that the increased weight is not within the range of the set weight of the item corresponding to the item information acquired in step S103 (step S105; No), the registration processing unit 104 causes the display 21 to display notification information in cooperation with the display control unit 106 (step S107). Then, the control unit 11 returns the process to step S104.

On the other hand, in step S102, when it is determined that the item code is not acquired (step S102; No), the cancellation processing unit 105 determines whether the weight of the shopping baskets 16 and 17 is reduced based on the weight measured by the weighing unit 103 (step S111).

In step S111, when it is determined that the weight of the shopping baskets 16 and 17 is reduced (step S111; Yes), the cancellation processing unit 105 refers to the item registration file 123 and extracts an item corresponding to the reduced weight (step S112). Next, the cancellation processing unit 105 cooperates with the display control unit 106 to display a cancellation candidate screen Gb on the display 21, the cancellation candidate screen Gb displaying the extracted items in a selectable manner (step S113).

Next, the operation instruction acquisition unit 101 determines whether or not selection of an item to be cancelled is received on the cancellation candidate screen Gb (step S114). In step S114, when it is determined that the selection of the item to be cancelled is not received (step S114; No), the control unit 11 repeats the determination of step S114. On the other hand, in step S114, when it is determined that the selection of the item to be cancelled is received (step S114; Yes), the cancellation processing unit 105 refers to the item registration file 123 and changes the cancel flag of the item of which the selection is received to the on state (step S115).

Next, the cancellation processing unit 105 causes the display 21 to display the item registration screen Ga reflecting the state of the cancel flag using the display control unit 106 (step S116). Then, the control unit 11 advances the processing to step S121. Next, in step S111, when it is determined that the weight of the shopping baskets 16 and 17 is not reduced (step S111; No), the operation instruction acquisition unit 101 determines whether or not the registration of all items is completed in the item registration screen Ga (step S121).

In step S121, when it is determined that registration of all items is not completed (step S121; No), the control unit 11 returns the process to step S102, and when it is determined that registration of all items is completed (step S121; Yes), the control unit 11 ends the process.

Through the above-described process, when the weight of the shopping baskets 16 and 17 is reduced, the shopping cart 10 (item registration device for shopping cart) can extract the item corresponding to the reduced weight from the item registration file 123 and display the cancellation candidate screen Gb, which shows cancellation candidates in a selectable manner, on the display 21. In addition, when the selection of the item to be cancelled is received from the cancellation candidate screen Gb, the shopping cart 10 can change the cancel flag of the item of which the selection is received to the on state in the item registration file 123 and display the item registration screen Ga reflecting the state of the cancel flag on the display 21.

As described above, the shopping cart 10 of the present embodiment includes the item code acquisition unit 102 that acquires an item code (an example of identification information) capable of identifying an item, the registration processing unit 104 that registers an item for which the item code is acquired, the weighing unit 103 that measures the weight of an item accommodated in the shopping cart 10, the cancellation processing unit 105 that extracts an item corresponding to the weight of the decrease from among items registered by the registration processing unit 104 in a case where the weight measured by the weighing unit 103 decreases, and the display control unit 106 that displays the item extracted by the cancellation processing unit 105 on the display 21 in a selectable manner.

Accordingly, when the weight of the shopping baskets 16 and 17 is reduced, the shopping cart 10 may display a screen on the display 21, the screen showing items corresponding to the reduced amount of the weight, that is, cancel candidates, among the registered items, in a selectable manner. Then, the customer can cancel the registration of the selected item by selecting the item from the cancellation candidates displayed in a selectable manner. Therefore, the shopping cart 10 can reliably cancel the registered item.

The above-described embodiments can be modified as appropriate by changing a part of the configuration or the function of each of the above-described devices. Therefore, in the following, some modifications according to the above-described embodiments will be described as other embodiments. Note that, in the following, differences from the above-described embodiments will be mainly described, and detailed description of features common to the contents already described will be omitted. The modifications described below may be implemented individually or in combination as appropriate.

### First Modification

In the above-described embodiment, when the cancellation processing unit 105 determines that the weight of the shopping baskets 16 and 17 has decreased due to an item being taken out from the shopping baskets 16 and 17 by the customer, the cancellation candidate screen Gb in which the cancellation candidate is displayed in a selectable manner is displayed on the display 21. In the present modification, a configuration will be described in which an operation element for canceling registration is provided on the item registration screen Ga, and after the customer selects an item to be canceled by operating the operation element, the item to be canceled is taken out from the shopping baskets 16 and 17.

First, an item registration screen Ga having a configuration different from that of the embodiment will be described.

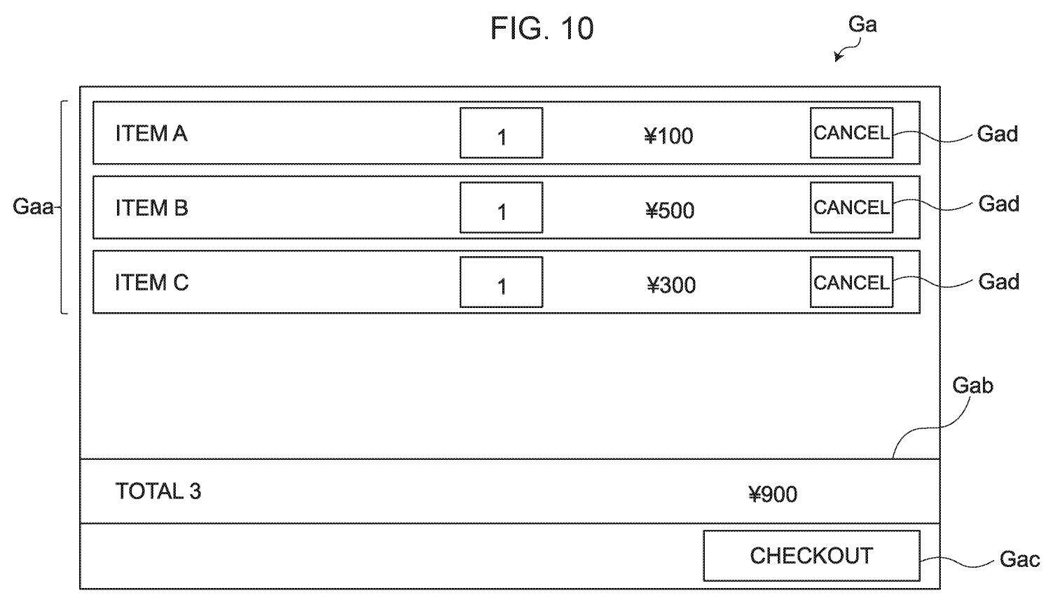

FIG. 10 is a diagram illustrating an example of a screen displayed on the display 21 of the shopping cart 10 according to the first modification. FIG. 10 shows an example of a screen of the item registration screen Ga displayed on the display 21 in a state where a plurality of items are registered in the item registration file 123. In FIG. 10, the same reference numerals denote the same elements as those in FIG. 6, and the description thereof will be omitted.

As illustrated in FIG. 10, for example, a registration detail field Gaa, a total purchase amount field Gab, a checkout button Gac, and a cancel button Gad are displayed on the item registration screen Ga.

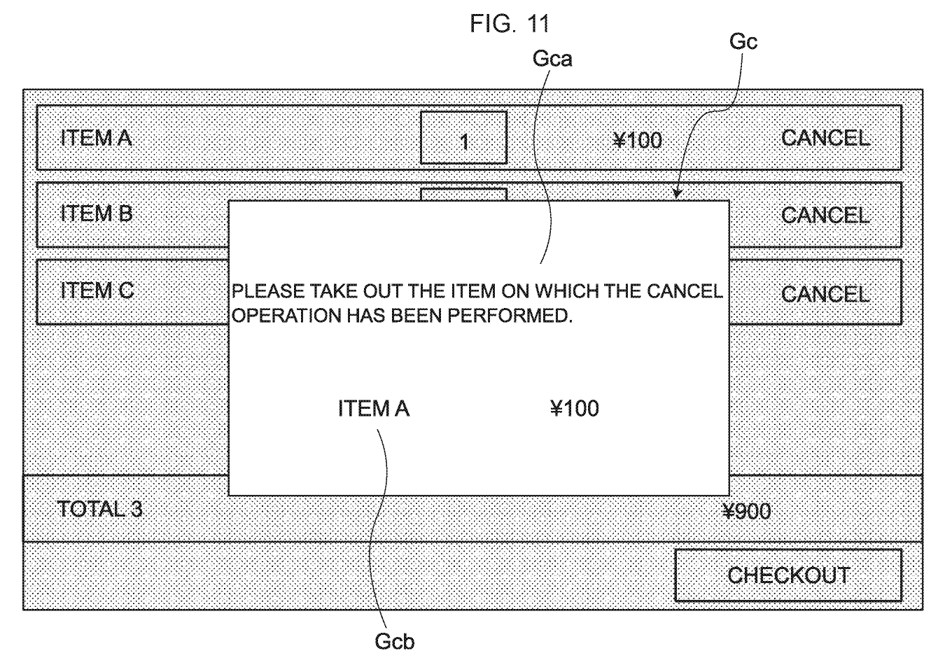

The cancel button Gad is an operation element for declaring cancellation of registration of an item. The cancel button Gad is provided for each item displayed in the registration detail field Gaa. For example, when the cancel button Gad is operated, the operation instruction acquisition unit 101 receives an instruction to cancel the registration of the item corresponding to the operated cancel button Gad. Further, when the operation instruction acquisition unit 101 receives an instruction to cancel the registration of the item, the cancellation processing unit 105 cooperates with the display control unit 106 to display a guide screen Gc shown in FIG. 11 on the display 21.

FIG. 11 is a diagram illustrating another screen example displayed on the display 21 of the shopping cart 10 according to the first modification. FIG. 11 shows an example of a guide screen Gc displayed on the display 21 when the cancel button Gad is operated on the item registration screen Ga of FIG. 10.

The display control unit 106 may display the guide screen Gc so as to be superimposed on the item registration screen Ga. In this case, for the purpose of clearly indicating selectable screens to the customer, it is preferable to display the item registration screen Ga grayed out.

As illustrated in FIG. 11, for example, a message Gca and a cancel item field Gcb are displayed on the guide screen Gc.

The message Gca is, for example, text for prompting the customer to take out the item corresponding to the cancel button Gad operated on the item registration screen Ga from the shopping baskets 16 and 17. The message Gca may include an operation instruction on the guide screen Gc.

In the cancel item field Gcb, for example, item information of an item corresponding to the cancel button Gad operated on the item registration screen Ga is displayed.

The operation instruction acquisition unit 101 determines whether the cancel button Gad is operated from the item registration screen Ga.

When the operation instruction acquisition unit 101 determines that the cancel button Gad is operated from the item registration screen Ga, the cancellation processing unit 105 cooperates with the display control unit 106 to display the guide screen Gc on the display 21.

The cancellation processing unit 105 determines whether the weight measured by the weighing unit 103 has decreased. When it is determined that the weight has decreased, the cancellation processing unit 105 determines whether the reduced weight matches the weight set for the item corresponding to the cancel button Gad operated on the item registration screen Ga. Here, the consistency means that the reduced weight is included in the range between the upper limit and the lower limit of the weight of the set item.

When it is determined that the reduced weight is not within the range of the weight set for the item corresponding to the cancel button Gad operated on the item registration screen Ga, the cancellation processing unit 105 displays notification information on the display 21. Here, the notification information includes a message indicating that the weight of the item corresponding to the cancel button Gad operated on the item registration screen Ga, in other words, the weight of the item for which the cancellation of the registration is instructed, does not match the weight of the item taken out from the shopping baskets 16 and 17.

In addition, when it is determined that the reduced weight is within the range of the weight set in the item corresponding to the operated cancel button Gad on the item registration screen Ga, the cancellation processing unit 105 refers to the item registration file 123 and changes the cancel flag of the item corresponding to the operated cancel button Gad to the on state. Further, the cancellation processing unit 105 causes the display 21 to display an item registration screen Ga reflecting the state of the cancel flag as the display control unit 106.

The item registration screen Ga and the guide screen Gc are displayed on the display 21 by executing the following processing, for example.

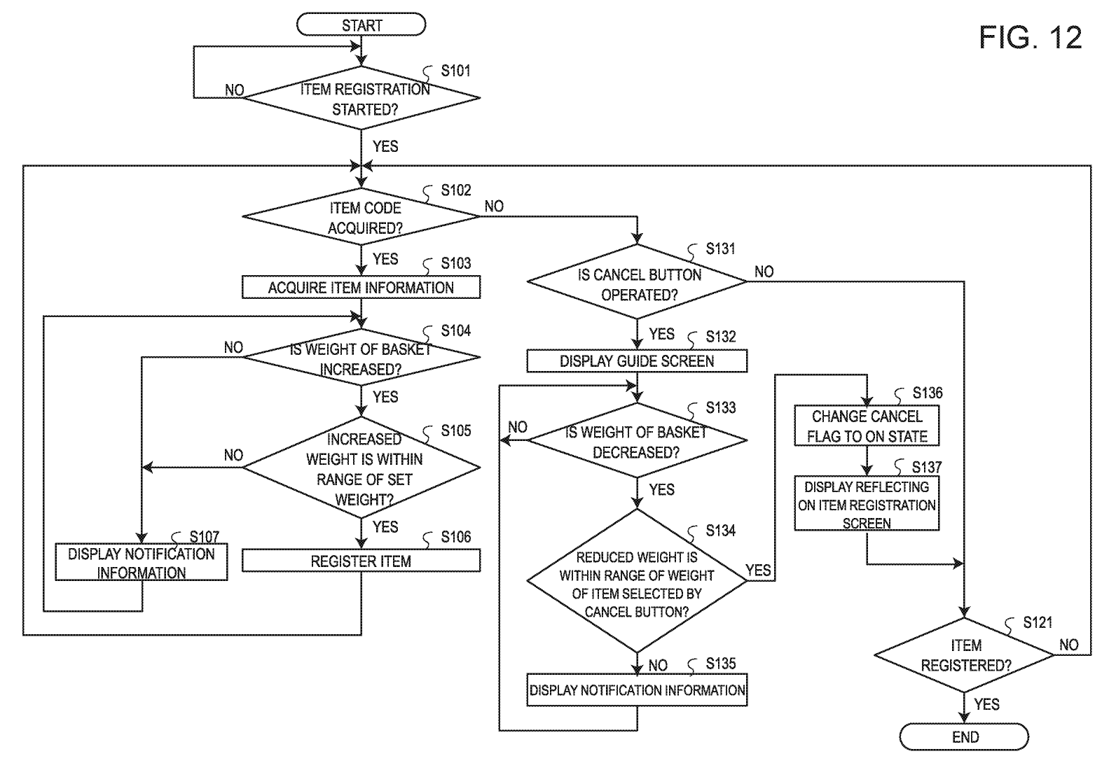

FIG. 12 is a flowchart of processing performed by the shopping cart 10 according to the first modification. In FIG. 12, the same reference numerals denote the same processes as those in the flowchart illustrated in FIG. 9, and the description thereof will be omitted.

In step S102, when it is determined that the item code is not acquired (step S102; No), the operation instruction acquisition unit 101 determines whether the cancel button Gad has been operated on the item registration screen Ga (step S131). When it is determined that the cancel button Gad is operated (step S131; Yes), the cancellation processing unit 105 cooperates with the display control unit 106 to display the guide screen Gc on the display 21 (step S132).

Next, the cancellation processing unit 105 determines whether the weight of the shopping baskets 16 and 17 has decreased based on the weight measured by the weighing unit 103 (step S133). When it is determined in step S133 that the weight of the shopping baskets 16 and 17 has not decreased (step S133; No), the control unit 11 returns the process to step S133.

In step S133, when it is determined that the weight of the shopping baskets 16 and 17 is reduced (step S133; Yes), the cancellation processing unit 105 determines whether the reduced weight is within the range of the weight set for the item selected in step S131 (step S134).

In step S134, when it is determined that the decreased weight is not within the range of the weight set for the item selected in step S131 (step S134; No), the cancellation processing unit 105 displays notification information on the display 21 in cooperation with the display control unit 106 (step S135). Then, the control unit 11 returns the process to step S133.

In step S134, when it is determined that the decreased weight is within the range of the weight included in the item information of the item selected in step S131 (step S134; Yes), the cancellation processing unit 105 refers to the item registration file 123 and changes the cancel flag of the item corresponding to the operated cancel button Gad to the on state (step S136).

Next, the cancellation processing unit 105 cooperates with the display control unit 106 to display the item registration screen Ga reflecting the state of the cancel flag on the display 21 (step S137). Then, the control unit 11 advances the processing to step S121.

On the other hand, in step S131, when it is determined that the cancel button Gad is not operated (step S131; No), the operation instruction acquisition unit 101 determines whether or not registration of all items is completed on the item registration screen Ga (step S121).

According to the above-described process, when the cancel button Gad has been operated on the item registration screen Ga, the shopping cart 10 (item registration device for shopping cart) can display the guide screen Gc for prompting the customer to take out the item corresponding to the operated cancel button Gad on the display 21. In addition, when the shopping cart 10 determines that the weight of the shopping baskets 16 and 17 is reduced, the shopping cart 10 determines whether the reduced weight is within the range of the weight of the item corresponding to the operated cancel button Gad. Then, when it is determined that the decreased weight is within the range of the weight of the item corresponding to the operated cancel button Gad, the cancel flag of the item corresponding to the operated cancel button Gad in the item registration file 123 is changed to the on state, and the item registration screen Ga reflecting the state of the cancel flag can be displayed on the display 21.

Accordingly, the shopping cart 10can accept an instruction related to cancellation of registration from the item registration screen Ga. In addition, the shopping cart 10 (item registration device for shopping cart) can determine whether the weight of the item taken out from the shopping baskets 16 and 17 is within the range of the weight of the item for which the registration cancellation instruction was received, based on the decrease in the weight of the shopping baskets 16 and 17 and the weight of the item registered in the item registration file 123, and display the notification information on the display 21 when the weight of the item is not within the range. Therefore, the shopping cart 10 (item registration device for shopping cart) can reliably cancel the registered item.

### Second Modification

In the present modification, a processing example will be described for a case where, when the item information acquired by the registration processing unit 104 is registered in the item registration file 123, an item to be registered (hereinafter, also referred to as an item Y) has the same item code as an item whose cancel flag has been changed to the on state previously by the cancellation processing unit 105 (hereinafter, also referred to as an item Z).

First, when registering the acquired item information in the item registration file 123, the registration processing unit 104 determines whether an item having the same item code as the item code of the item Y is registered in the item registration file 123 with the cancel flag in the on state. In other words, the registration processing unit 104 determines whether the item Z is registered in the item registration file 123. Then, when it is determined that the item is registered in the item registration file 123 with the cancel flag in the on state (that is, item Z is registered in the item registration file 123), the cancellation processing unit 105 changes the cancel flag of item Z from the on state to the off state. Then, the cancellation processing unit 105 cooperates with the display control unit 106 to display the item registration screen Ga reflecting the state of the cancel flag on the display 21.

In this case, the registration detail field Gaa of the item registration screen Ga is displayed in a state where the indication (for example, double lines) for indicating that the item Z is the canceled item is deleted. Accordingly, the customer can visually determine that the item that has been once cancelled is registered again.

The registration processing unit 104 may register the item Y in the item registration file 123 in a state where the cancel flag is in the off state, instead of changing the cancel flag of the item Z from the on state to the off state.

In this case, both item Y and item Z, which have the same item code, are displayed in the registration detail field Gaa of the item registration screen Ga. To be more specific, item Y with the cancel flag in the off state and item Z with the cancel flag in the on state are displayed. Accordingly, the customer can visually determine that the item that was once cancelled is registered again.

Therefore, according to the present modification, when the item having the same item code as the cancelled item is registered again, the shopping cart 10 (item registration device for shopping cart) can reflect the registration on the item registration screen Ga and display the item registration screen Ga on the display 21.

### Third Modification

In the above-described embodiments, the shopping cart 10 is configured to include the upper basket support frame 6 and the lower basket support frame 7, but embodiments of the present disclosure are not limited thereto, and the shopping cart 10 may be configured to include only the upper basket support frame 6 (or the lower basket support frame 7).

The program executed by the shopping cart 10 (item registration device for shopping cart) according to the above-described embodiments and modifications may be stored in a computer connected to a network such as the Internet and provided by being downloaded via the network. The program executed by the shopping cart 10 (item registration device for shopping cart) according to the above-described embodiments and modifications may be provided or distributed via a network such as the Internet.

The program executed by the shopping cart 10 (item registration device for shopping cart) of the above-described embodiment is provided in a state of being incorporated in a ROM, a storage unit, or the like in advance. The computer program executed by each device of the above-described embodiment may be recorded and provided in a computer-readable recording medium such as a compact disc read only memory (CD-ROM), a flexible disk (FD), a compact disc recordable (CD-R), and a digital versatile disk (DVD) in a file of an installable format or an executable format.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A shopping cart comprising:
one or more frames on which one or more containers for storing one or more items can be placed;
a weight sensor configured to measure a weight of the one or more containers placed on the one or more frames;
a scanner configured to read identification information identifying an item;
a display attached to the one or more frames;
a memory that stores a program; and
a processor configured to execute the program to:
upon reading of identification information by the scanner, register an item associated with the identification information for purchase,
determine whether a weight of the one or more containers measured by the weight sensor decreases, and
in response to determining that the weight decreases, determine one or more candidate items corresponding to an amount of the decrease in the weight from among registered items, generate a cancellation screen on the display, the cancellation screen displaying the one or more candidate items in a selectable manner, and upon selection of one of the one or more candidate items through the cancellation screen, cancel registration of the selected item.

2. The shopping cart according to claim 1, wherein
the processor is configured to execute the program to generate a registration screen on the display, the registration screen displaying the registered items and the item for which registration has been cancelled in a distinguishable manner.

3. The shopping cart according to claim 2, wherein
the registration screen displays the item for which registration has been cancelled with a strikethrough.

4. The shopping cart according to claim 1, wherein
the one or more candidate items are determined by identifying a registered item having a set weight range that includes the amount of the decrease in the weight measured by the weight sensor.

5. The shopping cart according to claim 1, further comprising:
an upper basket support frame;
a lower basket support frame; and
a suspension frame connecting the lower basket support frame to the upper basket support frame, wherein
the weight sensor is disposed below the upper basket support frame to measure a total weight of the one or more containers placed on the upper basket support frame and the lower basket support frame.

6. The shopping cart according to claim 1, wherein
the processor is configured to execute the program to:
before determining the one or more candidate items, generate a registration screen on the display, the registration screen displaying the registered items, and
when displaying the cancellation screen, update the registration screen to be displayed in a grayed-out manner.

7. The shopping cart according to claim 1, wherein
the processor is configured to execute the program to:
after cancelling the registration of the selected item, acquire identification information of a new item via the scanner,
determine whether the new item matches the selected item for which registration has been cancelled, and
in response to determining that the new item matches the selected item, register the selected item again and update the display to indicate that the selected item is registered.

8. A method for registering items on a shopping cart including a scanner, a weight sensor, and a display, the method comprising:
upon the scanner reading identification information, registering an item associated with the identification information for purchase;
determining whether a weight of one or more containers for storing one or more items, measured by the weight sensor decreases; and
in response to determining that the weight decreases, determining one or more candidate items corresponding to an amount of the decrease in the weight from among registered items, generating a cancellation screen on the display, the cancellation screen displaying the one or more candidate items in a selectable manner, and upon selection of one of the one or more candidate items through the cancellation screen, cancelling registration of the selected item.

9. The method according to claim 8, further comprising:
generating a registration screen on the display, the registration screen displaying the registered items and the item for which registration has been cancelled in a distinguishable manner.

10. The method according to claim 9, wherein
the registration screen displays the item for which registration has been cancelled with a strikethrough.

11. The method according to claim 8, wherein
determining the one or more candidate items includes identifying a registered item having a set weight range that includes the amount of the decrease in the weight measured by the weight sensor.

12. The method according to claim 8, wherein
the weight is measured by the weight sensor disposed below an upper basket support frame to which a lower basket support frame is connected through a suspension frame, and
the weight corresponds to a total weight of the one or more containers placed on the upper basket support frame and the lower basket support frame.

13. The method according to claim 8, further comprising:
before determining the one or more candidate items, generating a registration screen on the display, the registration screen displaying the registered items; and
when displaying the cancellation screen, updating the registration screen to be displayed in a grayed-out manner.

14. The method according to claim 8, further comprising:
after cancelling the registration of the selected item, acquiring identification information of a new item via the scanner;
determining whether the new item matches the selected item for which registration has been cancelled; and
in response to determining that the new item matches the selected item, registering the selected item again and updating the display to indicate that the selected item is registered.

15. An item registration device attachable to a shopping cart, the item registration device comprising:
a display;
a memory that stores a program; and
a processor configured to execute the program to:
upon receipt of identification information from a scanner provided on the shopping cart, register an item associated with the identification information for purchase,
acquire measurement data from a weight sensor provided on the shopping cart, and determine whether a weight of one or more containers placed on the shopping cart decreases based on the measurement data, and
in response to determining that the weight decreases, determine one or more candidate items corresponding to an amount of the decrease in the weight from among registered items, generate a cancellation screen on the display,
the cancellation screen displaying the one or more candidate items in a selectable manner, and upon selection of one of the one or more candidate items through the cancellation screen, cancel registration of the selected item.

16. The item registration device according to claim 15, wherein
the processor is configured to execute the program to generate a registration screen on the display, the registration screen displaying the registered items and the item for which registration has been cancelled in a distinguishable manner.

17. The item registration device according to claim 16, wherein
the registration screen displays the item for which registration has been cancelled with a strikethrough.

18. The item registration device according to claim 15, wherein
the one or more candidate items are determined by identifying a registered item having a set weight range that includes the amount of the decrease in the weight.

19. The item registration device according to claim 15, wherein
the processor is configured to execute the program to:
before determining the one or more candidate items, generate a registration screen on the display, the registration screen displaying the registered items, and
when displaying the cancellation screen, update the registration screen to be displayed in a grayed-out manner.

20. The item registration device according to claim 15, wherein
the processor is configured to execute the program to:
after cancelling the registration of the selected item, acquire identification information of a new item via the scanner,
determine whether the new item matches the selected item for which registration has been cancelled, and
in response to determining that the new item matches the selected item, register the selected item again and update the display to indicate that the selected item is registered.
